(19) United States
(12) Patent Application Publication
(10) Pub. No.: US 2026/0145016 A1
(43) Pub. Date: May 28, 2026

(54) AQUEOUS FOAM COMPOSITIONS AND METHODS

(71) Applicant: Vorbeck Materials Corp., Columbia, MD (US)

(72) Inventors: Kate Redmond, Baltimore, MD (US); Dan Scheffer, Frederick, MD (US); John S. Lettow, Washington, DC (US)

(73) Assignee: Vorbeck Materials Corp., Columbia, MD (US)

(21) Appl. No.: 19/399,816

(22) Filed: Nov. 25, 2025

Related U.S. Application Data
(60) Provisional application No. 63/725,051, filed on Nov. 26, 2024.

(51) Int. Cl. A62D 1/02

(52) U.S. Cl. CPC A62D 1/0071

(57) ABSTRACT

Embodiments of the present disclosure relate to fire suppressing aqueous foam compositions and related methods. The compositions are configured to suppress Class 3 fires and is non-fluorinated. The compositions include water, a surfactant, and carbon elements (e.g., graphene, graphene oxide and/or graphite oxide). The surfactant is a non-fluorinated surfactant. The carbon element is present at about 0.1-10 wt %. The surfactant is anionic, cationic, nonionic, or zwitterionic and is present at 2-25 wt %. The compositions include a water-soluble polymer present at 0.5-3.0 wt %, a solvent present at 3-20 wt %. The solvent includes a glycol and/or glycol ether. The includes a biocide and/or corrosion inhibitor. The corrosion inhibitor is present at 0.001-10 wt %. In one embodiment, a method of preparing the aqueous foam composition is disclosed. The method includes combining the water, surfactant, and carbon element to generate an aeratable slurry.

### RELATED APPLICATIONS

This application claims the benefit of provisional Appl. No. 63/725,051, filed Nov. 26, 2024, which is hereby incorporated by reference in its entirety.

### FEDERALLY SPONSORED RESEARCH AND DEVELOPMENT

This invention was made with government support under Solicitation No. SP4701-23-C-0030 awarded by the DEFENSE LOGISTICS AGENCY (DLA). The government has certain rights in the invention.

### TECHNICAL FIELD

The present disclosure relates generally to foam compositions and specifically to aqueous foam compositions for extinguishing combustion events.

### BACKGROUND

Firefighting foams are widely used by military and civilian organizations to suppress fires (combustion events), and particularly class B (flammable liquid) fires. Class B fires typically involve flammable liquids or gases, such as hydrocarbon-based materials such as gasoline, kerosene, greases, solvents, oils, paints, varnishes, and the like. Attempts to use water alone to extinguish Class B fires is extremely dangerous, as the fuels are typically immiscible with and lighter than water, causing them to rise to the surface, allowing the flames to spread. Furthermore, the heat can vaporize water, creating steam that can splatter and further spread the fire. Consequently, water is typically used with a foam that can act to smoother the fire and create a vapor barrier between the fuel and oxygen to prevent reignition thereof.

Traditionally, aqueous film-forming foams (AFFFs) have been widely used to fight Class B fires. These foams are based on polyfluoroalkyl surfactants, such as those based on perfluorooctanoic acid (PFOA) and perfluorooctanesulfonic acid (PFOS), which have been found to be environmentally persistent, bioaccumulative (i.e., accumulates over time in biological organisms exposed to substance), toxic, and possibly carcinogenic. The use of AFFFs thus presents a significant health threat to firefighters, bystanders, and the environment, as wastewater and runoff containing AFFFs can contaminate nearby or adjacent bodies of water and soil. As such, consumers would benefit from firefighting foams that are neither environmentally persistent, bioaccumulative, toxic, nor possibly carcinogenic.

### SUMMARY

Embodiments of the present disclosure relate to aqueous foam compositions that are non-fluorinated. The aqueous foam composition includes water, a surfactant, and carbon elements. The carbon element includes graphene, graphene oxide and/or graphite oxide. The surfactant is non-fluorinated. The aqueous foam composition is configured to be aerated prior to use. The carbon element is present at 0.1-10 wt %. In some embodiments, the surfactant includes an anionic surfactant, cationic surfactant, nonionic surfactant, and/or zwitterionic surfactant. The aqueous foam compositions can include the surfactant present at 2-25 wt %. In certain embodiments, the aqueous foam composition includes a water-soluble polymer present at 0.05-3 wt %.

In yet still other embodiments, the aqueous foam composition includes a solvent present at 3-20 wt % that includes a glycol and/or glycol ether. In some embodiments, the aqueous foam composition includes a biocide and/or corrosion inhibitor. When present, the corrosion inhibitor has a weight percent of 0.002-1. In one embodiment, a method of preparing an aqueous foam composition is disclosed. Carbon elements are formed. Water, a surfactant, and the carbon elements are combined to thereby generate an aeratable slurry. Applicable carbon elements include, but are not limited to, graphene, graphene oxide and/or graphite oxide. To ensure the aqueous foam compositions are free of PFAS and PFOS chemicals, only non-fluorinated surfactants are used. Applicable surfactants include those that are anionic, cationic, nonionic, and/or zwitterionic. The surfactant and carbon elements are present at 2-25 wt % and 0.1-10 wt %, respectively. A water-soluble polymer, solvent, biocide, and/or corrosion inhibitor are further combined in the aeratable slurry. The water-soluble polymer is present at 0.05-3 wt %. The solvent is present at 3-20 wt % and includes a glycol and/or glycol ether. When used, the corrosion inhibitor is present at 0.002-1 wt %.

Other embodiments relate to methods of preparing aqueous foam compositions. The method includes combining water, a surfactant, and carbon element(s) to generate an aeratable slurry. Applicable carbon elements include, but are not limited to, graphene, graphene oxide, and/or graphite oxide. To ensure the aqueous foam compositions are free of PFAS and PFOS chemicals, only non-fluorinated surfactants are used. In certain embodiments, the method includes combining water, the surfactant, the carbon element, and at least one of a solvent, biocide, corrosion inhibitor to thereby generate the aeratable slurry.

### BRIEF DESCRIPTION OF THE DRAWINGS

FIG. 1 is a diagram that illustrates mixing an aqueous foam composition together with water and subsequent conversion to a finished foam, in accordance with some embodiments.

FIG. 2 is a diagram that illustrates the aqueous foam composition applied to and spreading across a combustion event associated with the thermal ignition of a hydrocarbon fuel, in accordance with certain embodiments.

FIG. 3 depicts process steps of a method for preparing the aqueous foam composition of FIG. 1, according to some embodiments.

### DETAILED DESCRIPTION

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. As used herein, “a” and “an” refer to “one or more” or “at least one.”

Firefighting foams are widely used by military and civilian organizations to suppress fires (“combustion events”), and particularly class B (flammable liquid) fires. Class B fires typically involve flammable liquids or gases, such as hydrocarbon-based materials such as gasoline, kerosene, greases, solvents, oils, paints, varnishes, and the like. Using water alone to suppress these fires is extremely dangerous, as the fuels are typically immiscible with and lighter than water, causing them to rise to the surface, allowing the flames to spread. Furthermore, the heat can vaporize water, creating steam that can splatter and further spread the fire. Consequently, water is typically used with a foam that can act to smoother the fire and create a vapor barrier between the fuel and oxygen to prevent reignition.

Traditionally, aqueous film-forming foams (AFFFs) have been widely used to fight fires. These foams are based on polyfluoroalkyl surfactants such as those based perfluorooctanoic acid (PFOA) and perflurooctanesulfonic acid (PFOS), which have been found to be environmentally persistent, bioaccumulative (i.e., accumulates in an organism), toxic, and possibly carcinogenic. The use of AFFFs thus presents a significant health threat to firefighters, bystanders, and the environment, as wastewater and runoff containing AFFFs can contaminate nearby or adjacent bodies of water and soil. As such, consumers would benefit from firefighting foams that are neither environmentally persistent, bioaccumulative, toxic, nor possibly carcinogenic.

Embodiments of the present disclosure seek to provide aqueous foam compositions configured to extinguish combustion events associated with the thermal ignition of hydrocarbon fuels. Other aspects seek to provide aqueous foam compositions having graphene oxide and/or graphite oxide. Additional aspects seek to provide aqueous foam compositions configured to be aerated prior to use.

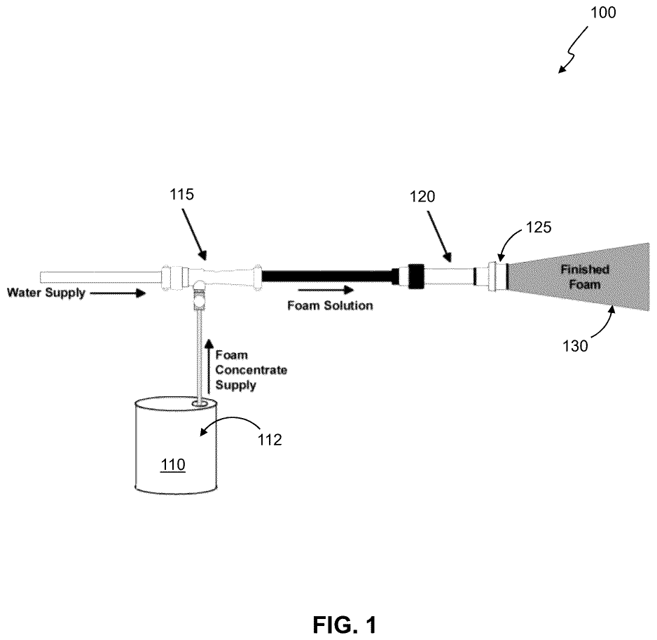

Turning now to the Figures. FIG. 1 is a diagram illustrating a proportioning equipment, generally 100, that mixes foam concentrate 112 (i.e., a concentrate of the fire suppressing aqueous foam composition of the instant disclosure) with water for conversion to finished foam 130, in accordance with some embodiments. Proportioning equipment 100 includes proportioning device 115 that receives a water supply (e.g., from a water tank or other water source) and foam concentrate 112. Proportioning device 115 can include a ratio controller to mix the desired percentage of concentrate with water.

Proportioning equipment 100 provides a calibrated ratio of foam concentrate 112 and water to discharge device 120, which is configured to deliver the finished foam solution to the hazard area. In preferred embodiments, discharge device 120 includes aspirating nozzle 125. In other embodiments, discharge device 120 can include foam monitors, sprinklers, or nozzles to deliver the finished foam to the hazard area (e.g., Class A fires and/or Class B fires). In addition, the aqueous foam compositions of the present disclosure can be configured as wetting agents to help extinguish class A fires.

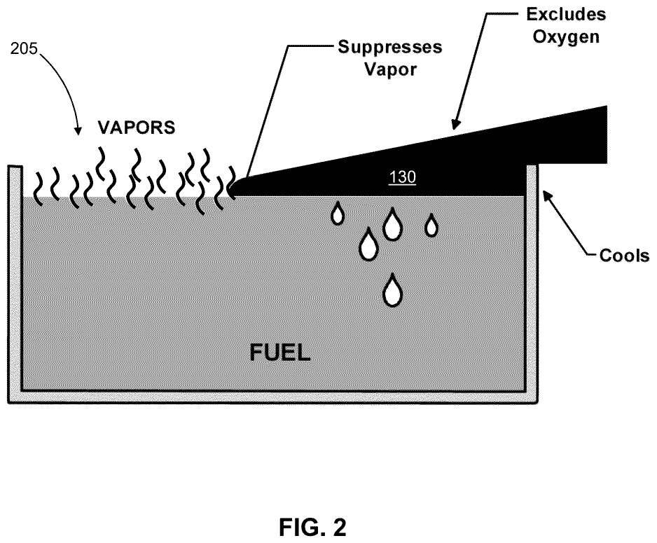

FIG. 2 is a diagram that illustrates finished foam 130 applied to a fuel fire (e.g., a hydrocarbon fuel fire), generally 205, in accordance with certain embodiments. Not to be limited by theory, finished foam 130 is configured to form an aqueous film that spreads across the surface of fuel fire 205 and/or around obstacles proximate thereto to thereby extinguish fuel fire 205. Finished foam 130 is configured to be resistant not only to thermal radiation emanating from fuel fire 205 or objects proximate thereto, but also “fuel pick-up” so that finished foam 130 does not become saturated with the fuel and thermally ignite. Further extinguishing characteristics of finished foam 130 include the ability of finished foam 130 to suppress (e.g., trap) flammable vapors emanating from the fuel fire 205.

In general, the aqueous foam compositions of the instant disclosure are typically a stable aggregation of small bubbles of lower density than oil or water exhibiting a tenacity for covering horizontal surfaces. Such aqueous foam compositions are configured to flow freely over a burning liquid surface and form an air-excluding, continuous blanket that seals volatile combustible vapors from access to air. Aqueous foam compositions of the present disclosure can extinguish combustion events by separating the fuel from oxygen and thereby interrupt the combustion process.

In some embodiments, the aqueous foam composition can at least include water, a surfactant, and a carbon element, comprising graphene, graphite oxide, and/or graphene oxide. For example, the graphite oxide, graphene oxide, and graphene can be formed as described in U.S. Pat. No. 7,658,901 to Prud'homme et al., the disclosure of which is incorporated herein by reference in its entirety. Graphite oxide can be formed from graphite by oxidation and preferably has a carbon to oxygen ratio of from about 1.5:1 to about 3:1. Graphene oxide comprises single sheets of graphite oxide or few-layered structures of graphite oxide (preferably 1-5 layers). Graphene oxide can be formed from graphite oxide by ultrasonication of graphite oxide in a liquid solution (e.g., water).

Not to be limited by theory, the use of carbon elements enhances the performance and durability of the instant aqueous foam compositions. These carbon-based particles can adsorb at the air-water interface, where their high aspect ratio and amphiphilic (both hydrophobic and hydrophilic) properties create a dense barrier that reduces bubble coalescence. This stabilization mechanism strengthens the foam structure, improves resistance to collapse, and slows liquid drainage-crucial for applications requiring prolonged foam stability. Additionally, the carbon elements impart unique properties, such as thermal stability, which are especially valuable in fire suppression applications.

The surfactant is preferably non-fluorinated to ensure that the aqueous foam composition is neither environmentally persistent, bioaccumulative, toxic, nor carcinogenic. Applicable surfactants may include, but are not limited to, anionic surfactant cationic surfactant, cationic surfactants, nonionic surfactants, and zwitterionic surfactants.

In some aspects, the anionic surfactant can be an alkyl sulfate (e.g., sodium dodecyl sulfate (sodium lauryl sulfate), sodium decyl sulfate, and sodium octyl sulfate), and/or alkyl sulfonates. Examples of nonionic surfactants include alkyl glycosides and/or alkyl polyglycosides. Examples of zwitterionic surfactants include betaines (e.g., cocamidopropyl betaine), sulfobetaines, sultaines, alkylsulfobetaines, alkylbetaines, and/or N,N-dimethyldodecylamine N-oxide. In other aspects, the aqueous foam composition can further include one or more water-soluble polymers (e.g., polysaccharides, proteins, gums, and/or resins). Water-soluble polymers can be included in the aqueous foam composition to enhance the stability, effectiveness, and environmental compatibility of the aqueous foam composition.

These substances can function as film-formers, creating a cohesive and stable layer that helps to smother combustion events by cutting off the oxygen supply. Applicable water-soluble polymers include, but is not limited to, diutan gum, xantham gum as well as similar gums and polymers, such as gelatins, collagens, sodium alginate, celluloses (such as hydroxypropyl methyl cellulose, hydroxy ethyl cellulose, carboxy methyl cellulose, and similar cellulose-based polymers), agar gum, carrageenan, guar gum, tara gum, pectin, and similar water-soluble polymers. Water-soluble polymers can provide viscosity control, ensuring that the aqueous foam composition spreads evenly and maintains its structure over large areas.

Such water-soluble polymers can contribute to the aqueous foam composition's adhesive properties, allowing it to stick to surfaces and form a protective barrier. In certain embodiments, the water-soluble polymers can be naturally derived, thus offering biodegradability, making the aqueous foam composition more environmentally friendly compared to synthetic alternatives. Additionally, these components can work synergistically with other ingredients in the aqueous foam composition, such as surfactants and solvents, to enhance the overall fire-extinguishing capabilities.

In yet still other aspects, the aqueous foam compositions can further include at least one solvent. Solvents can enhance the extinguishing effectiveness of the aqueous foam compositions by reducing the surface tension of the aqueous foam composition, which allows it to spread quickly and form a thin, aqueous film over the surface of flammable hydrocarbon fuel. Additionally, solvents can contribute to the stability of the aqueous foam compositions, ensuring that it remains effective over a longer period by maintaining its structure and preventing it from breaking down too quickly. Furthermore, solvents aid in the rapid spreading of the aqueous foam composition across the hydrocarbon fuel surface, which is crucial for quickly covering and suppressing the combustion event.

Applicable solvents can include, but are not limited to, glycols (e.g., propylene glycol) and/or glycol ethers (e.g., diethylene glycol monobutyl ether). The aqueous foam composition can further include one or more biocides and/or corrosion inhibitors to further enhance its effectiveness. For example, biocides prevent bacterial and fungal growth within the aqueous foam composition, which is crucial because microbial contamination can degrade the foam's effectiveness and reduce its shelf life. By inhibiting microbial growth, biocides ensure that the aqueous foam composition maintains its intended properties, such as stability and film-forming ability, over time, which is vital for reliable combustion event suppression.

Corrosion inhibitors protect the storage and delivery systems from rust and corrosion, preventing damage that could lead to leaks or failures compromising the aqueous foam composition's performance. This protection extends the lifespan of firefighting equipment, reducing maintenance costs and ensuring readiness for emergency situations.

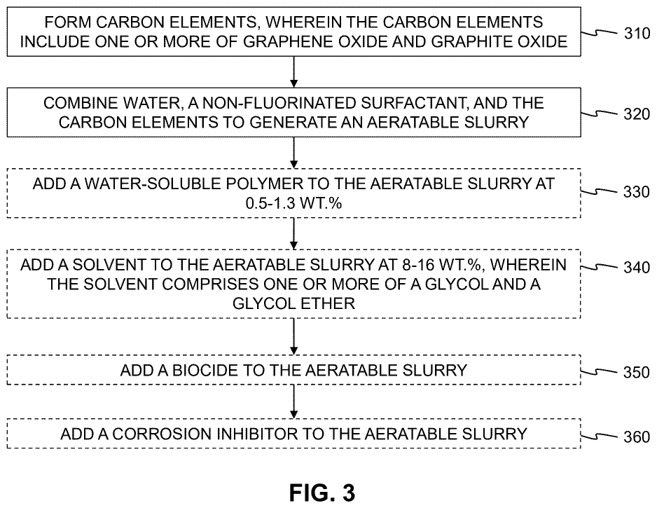

FIG. 3 depicts the process steps of a method for preparing the aqueous foam composition, according to some embodiments. At Step 310, carbon elements are formed. In certain embodiments, the carbon elements are preformed, thereby negating the need for Step 310. The carbon elements are preferably graphene, graphene oxide and/or graphite oxide. At Step 320, water, a surfactant, and the carbon elements are combined to generate an aeratable slurry. The components are preferably added stepwise to ensure that they are evenly distributed. In preferred embodiments, the components are combined in a manner such that the carbon elements are present at about 0.1-10 wt % and the surfactant is present at 2-25 wt % within the aeratable slurry.

Alternatively, Step 320 can further include the inclusion of a water-soluble polymer (Step 330), a solvent (Step 340), a biocide (Step 350), and/or a corrosion inhibitor (Step 360) to generate the aeratable slurry. For example, at Step 330, the water-soluble polymer is combined with water to thereby generate a polymer slurry, and the surfactant and the carbon element are combined with the polymer slurry to thereby generate the aeratable slurry. Here, the aeratable slurry can include the water-soluble polymer at 0.05-3.0 wt %, the solvent at 3-20 wt %, and the corrosion inhibitor at 0.002-1 wt %.

### EXAMPLES

Comparative Examples 1 and 2: A foam concentrate formulation is assembled by combining water, a water-soluble polymer, a glycol, a glycol ether, and surfactants. The foam concentrate is diluted at 3 wt % in water to make a foam solution. Fires are made in a 28 square foot steel pan using Jet A fuel (Comparative Example 1) and gasoline (Comparative Example 2). The foam solution is pumped through a foaming nozzle at 2 gallons per minute to generate a finished foam that is applied to the fuel fires and the time taken to fully extinguish the fire is recorded. The results are given in Table 1.

Examples 1 and 2: Graphene oxide is added to the foam concentrate of Comparative Examples 1 and 2 at 0.5 wt %, relative to the total weight of the foam concentrate and graphene oxide. The resulting foam concentrate is diluted at 3 wt % in water to make a foam solution. Fires are made in a 28 square foot steel pan using Jet A fuel (Example 1) and gasoline (Example 2). The foam solution is pumped through a foaming nozzle at 2 gallons per minute to generate a finished foam and applied to the fuel fires. Total time required to fully extinguish the fire (“extinguishing time”) is recorded. The results are given in Table 1.

TABLE 1

| | Fuel | Extinguishing Time (sec) |
|---|---|---|
| Comparative Example 1 | Jet A | 28 |
| Example 1 | Jet A | 21 |
| Comparative Example 2 | Gasoline | 55 |
| Example 2 | Gasoline | 43 |

A comparison of Comparative Example 1 and Example 1 shows a 25 percent reduction in extinguishing time for a Jet A fire when graphene oxide is added to the formulation. Similarly, a comparison of Comparative Example 2 and Example 2 shows a 22 percent reduction in extinguishing time for a gasoline fire when graphene oxide is added to the formulation.

Based on the foregoing, aqueous foam compositions and methods of preparing aqueous foam compositions have been disclosed in accordance with the present disclosure. However, numerous modifications and substitutions can be made without deviating from the scope of the present disclosure. Therefore, the present disclosure has been disclosed by way of example and not limitation.

What is claimed is:

1. A fire suppressing aqueous foam composition, comprising:
water;
a surfactant;
a carbon element;
wherein
the carbon element consists of at least one or more of graphene, graphene oxide and graphite oxide;
the surfactant is a non-fluorinated surfactant;
the aqueous foam composition is non-fluorinated; and
the aqueous foam composition is configured to be aerated prior to use.

2. The aqueous foam composition of claim 1, wherein
the carbon element is present at about 0.1-10 wt %.

3. The aqueous foam composition of claim 1, wherein
the surfactant comprises one or more of
an anionic surfactant; and
a cationic surfactant.

4. The aqueous foam composition of claim 1, wherein
the surfactant comprises one or more of
a nonionic surfactant; and
a zwitterionic surfactant.

5. The aqueous foam composition of claim 1, wherein
the surfactant is present at 2-25 wt %.

6. The aqueous foam composition of claim 1, further comprising:
a water-soluble polymer present at 0.05-3 wt %.

7. The aqueous foam composition of claim 1, further comprising:
a solvent present at 3-20 wt %;
wherein
the solvent comprises one or more of
a glycol; and
a glycol ether.

8. The aqueous foam composition of claim 1, further comprising a biocide.

9. The aqueous foam composition of claim 1, further comprising:
a corrosion inhibitor present at 0.002-1 wt %.

10. A method of preparing a fire suppressing aqueous foam composition, comprising:
combining water, a surfactant, and a carbon element to thereby generate an aeratable slurry;
wherein
the carbon element consists of at least one or more of graphene, graphene oxide, and graphite oxide;
the surfactant is a non-fluorinated surfactant; and
the aqueous foam composition is non-fluorinated.

11. The method of claim 10, wherein
the carbon element is present at about 0.1-10 wt %.

12. The method of claim 10, wherein
the surfactant comprises one or more of
an anionic surfactant; and
a cationic surfactant.

13. The method of claim 10, wherein
the surfactant comprises one or more of
a nonionic surfactant; and
a zwitterionic surfactant.

14. The method of claim 10, wherein
the surfactant is present at 2-25 wt %.

15. The method of claim 10, wherein
the step of combining, the water, the surfactant, and the carbon element to thereby generate the aeratable slurry comprises:
combining a water-soluble polymer and the water to thereby generate a polymer slurry; and
combining the surfactant, the carbon element, and the polymer slurry to thereby generate the aeratable slurry; and
the water-soluble polymer is present at 0.05-3 wt %.

16. The method of claim 10, wherein
the step of combining, the water, the surfactant, and the carbon element to thereby generate the aeratable slurry comprises:
combining the water, the surfactant, the carbon element, and a solvent to thereby generate the aeratable slurry;
the solvent
is present at 3-20 wt %.; and
comprises one or more of a glycol and a glycol ether.

17. The method of claim 10, wherein
the step of combining, the water, the surfactant, and the carbon element to thereby generate the aeratable slurry comprises:
combining the water, the surfactant, the carbon element, and a biocide to thereby generate the aeratable slurry.

18. The method of claim 10, wherein:
the step of combining, the water, the surfactant, and the carbon element to thereby generate the aeratable slurry comprises:
combining the water, the surfactant, the carbon element, and a corrosion inhibitor to thereby generate the aeratable slurry; and
the corrosion inhibitor is present at 0.002-1 wt %.

19. The method of claim 10, further comprising forming the carbon element.

20. A fire suppressing aqueous foam composition, comprising:
water;
a surfactant;
a carbon element;
a water-soluble polymer;
a solvent;
a corrosion inhibitor;
a biocide;
wherein
the surfactant
is a non-fluorinated surfactant;
is present at 2-25 wt %;
comprises one or more of an anionic surfactant, a cationic surfactant, a zwitterionic surfactant, and a nonionic surfactant;
the carbon element
consists of at least one or more of graphene, graphene oxide, and graphite oxide;
is present at about 0.1-10 wt %;
the water-soluble polymer is present at 0.0-3 wt %;
the solvent
is present at 3-20 wt %;
comprises one or more of a glycol and a glycol ether;
the corrosion inhibitor is present at 0.002-1 wt %; and
the aqueous foam composition is non-fluorinated.
